(19) United States
(12) Patent Application Publication
(10) Pub. No.: US 2021/0380324 A1
(43) Pub. Date: Dec. 9, 2021

(54) DISPOSABLE CUP LID FILM SYSTEM AND METHOD

(71) Applicant: Brian Garbutt, Irvine, CA (US)

(72) Inventor: Brian Garbutt, Irvine, CA (US)

(21) Appl. No.: 16/892,585

(22) Filed: Jun. 4, 2020

(51) Int. Cl. B65D 81/24; B65D 43/02; B65D 55/00

(52) U.S. Cl. CPC B65D 81/245; B65D 2543/00231; B65D 55/00; B65D 43/0202

(57) ABSTRACT

A bio-degradable plastic film designed to cover the top of a disposable coffee lid. The device effectively prevents unsanitary handling of the lid by workers preparing the beverage, ensuring that consumers receive a coffee lid that is clean and ready to drink from. The device keeps the beverage warm by trapping in heat until ready for consumption and prevents individuals from inadvertently making contact with an allergen.

### CROSS-REFERENCE TO RELATED APPLICATION(S)

The present application is related to and claims priority to U.S. Provisional Patent Application No. 62/814,558 filed Mar. 6, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of receptacles of existing art and more specifically relates to a disposable cup lid film system.

### RELATED ART

During the preparation of a cup of coffee in a restaurant or coffee shop, employees often touch dirty money and other surfaces and then place the coffee lid on the cup by touching the drinking surface with their hand. This causes the lid to be contaminated by germs and bacteria. In addition, employees may handle foods that a customer is allergic to, which are then passed onto the lid of the cup.

Re-usable tumblers or thermoses with lids that have inner seals may be used; however, mold can grow in these devices. Moldy seals can cause allergic reactions and respiratory problems that are resistant to antibiotics. A suitable solution is desired.

U.S. Pub. No. 2009/0223981 to William Levey relates to a sanitary barrier for beverage container lid. The described sanitary barrier for beverage container lid is attachable to lids that accompany beverage containers/cups, particularly disposable containers for coffee or other hot beverages. The sanitary barrier comprises a thin, flexible strip of material that covers the entire area on which consumers place their mouths. It is adhered to the lid with a light, food-grade adhesive. The sanitary barrier has an extended pull tab that is not adhered to the lid and extends beyond the bottom wall of the lid and can be easily gripped to allow the strip to be pulled up and away from the lid for easy removal of the sanitary barrier.

### SUMMARY OF THE INVENTION

In view of the foregoing disadvantages inherent in the known receptacles art, the present disclosure provides a novel disposable coffee cup lid film system. The general purpose of the present disclosure, which will be described subsequently in greater detail, is to provide an efficient and effective disposable coffee cup lid film system.

The present invention, Clean Lidz, provides an eco-friendly plastic film that covers the top of a coffee cup lid which prevents unsanitary handling by baristas and cashiers. As such it effectively ensures that the coffee cup lid is free of germs, contaminants and allergens. Further, it keeps hot drinks hot by trapping in heat until ready for consumption. As designed, it helps eliminate spillage by keeping the lid sealed.

Clean Lidz helps avoid having customers replace coffee cup lids with new lids which can escalate costs when the customers make the lid switch for a clean lid daily. Further, the device helps eliminate the need to offer plastic spout stoppers to stick in the cup hole to keep it warm and keep it from spilling.

A disposable coffee cup lid film system is disclosed herein in a preferred embodiment, the system comprising a plastic film for maintaining the cleanliness of a lid of a beverage container before drinking from it. In some versions, the plastic film is recyclable or biodegradable. For the remainder of this disclosure, plastic film encompasses recyclable plastic film and biodegradable plastic film and vice versa. The recyclable plastic film is removably coupled to the lid and removable just before drinking from the beverage container.

The recyclable plastic film is preferably transparent; the recyclable plastic film may be temporarily adhered to the lid via an adhesive (or other suitable attaching means) to effectively prevent human touch to the lid during handling. As such, the recyclable plastic film is an isolator to effectively prevent germ-transfer, allergen-transfer, bacteria-transfer, and virus-transfer to the lid during handling. In certain embodiments, the recyclable plastic film comprises functional indicia such as logos for advertising or to print instructions thereon.

According to another embodiment, a method of use for the disposable coffee cup lid film system is also disclosed herein, the method comprising the steps of coupling a recyclable plastic film to a lid, for maintaining the cleanliness of the lid of a beverage container before drinking from it and removing the recyclable plastic film from the lid just before drinking from the beverage container. The method may further include the step of adhering the recyclable plastic film to the lid during manufacture or after manufacture.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a disposable coffee cup lid film system, constructed and operative according to the teachings of the present disclosure.

FIG. 1 is a perspective view of the disposable coffee cup lid film system.

FIG. 2 is a perspective view of a lid of the disposable coffee cup lid film system of FIG. 1.

FIG. 3 is a perspective view of the film of the lid of FIG. 1.

FIG. 4 is a flow diagram illustrating a method of use for the disposable coffee cup lid film system.

The various embodiments of the present invention will hereinafter be described in conjunction with the appended drawings, wherein like designations denote like elements.

### DETAILED DESCRIPTION

As discussed above, embodiments of the present disclosure relate to a receptacle and, more particularly, to a disposable coffee cup lid film as used to improve the cleanliness of coffee lids for drinking it.

Generally, the disposable coffee cup lid film is a preventive measure (means) for keeping coffee cup lids sanitary. (The disclosure describes the cups as coffee cups. But the invention applies equally to cups in all types of disposable cups independent of the beverage). The present invention is a recyclable plastic film that is manufactured on top of a coffee cup lid. The film is specifically designed for disposable lids commonly used in coffee shops. The plastic film is removable and can be removed by the consumer once the beverage has been served. The film is designed to keep the lid and drinking surface free of germs, allergens, etc. The film may be made with various types of logos and designs. The device, when used, keeps hot drinks hot by trapping in heat until ready for consumption. As designed, it helps eliminate spillage by keeping the lid sealed.

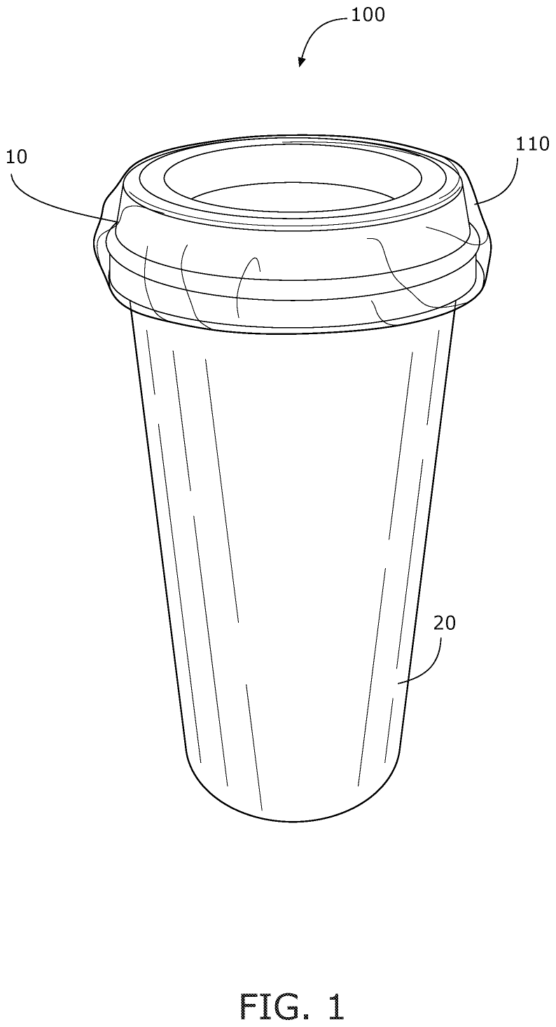

Referring now more specifically to the drawings by numerals of reference, there is shown in FIGS. 1-3, various views of a disposable coffee cup lid film system 100.

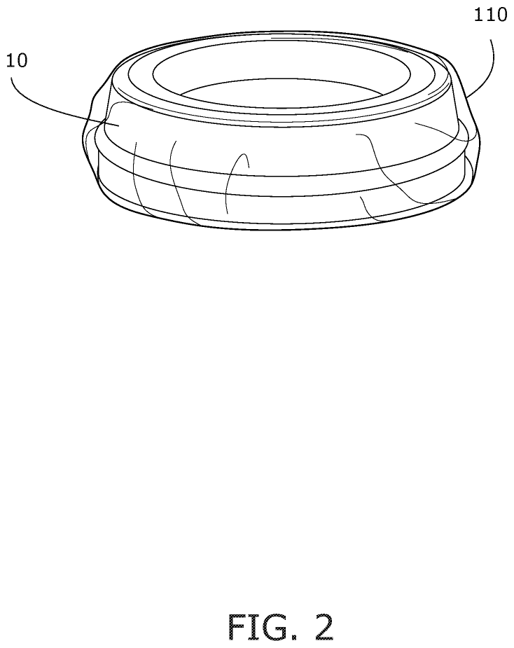

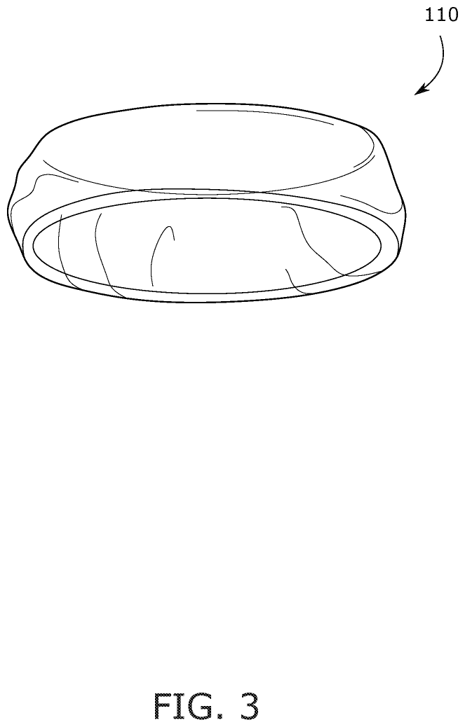

FIG. 1 shows a disposable coffee cup lid film system 100 during an ‘in-use’ condition, according to an embodiment of the present disclosure. Here, the disposable coffee cup lid film system 100 may be beneficial for use by a user to prevent the spread of germs, viruses, etc. on clean coffee lids. As illustrated, the disposable coffee cup lid film system 100 may include a recyclable plastic film 110 for maintaining cleanliness (preventing contamination) of a lid 10 of a beverage container 20 before drinking it, the recyclable plastic film 110 removably coupled to the lid 10 and removable just before drinking from the beverage container 20 via the lid 10. FIG. 2 shows the lid 10 with the connected recyclable plastic film 110. FIG. 3 shows the recyclable plastic film 110.

The recyclable plastic film 110 is transparent or colored and is temporarily adhered to the lid 10 for ease of removal but sufficiently affixed for handling until the point of removal for drinking from the beverage container 20. In some embodiments, the recyclable plastic film 110 comprises a tab engageable by a user, the tab allowing the recyclable plastic film 110 to be peeled back (preferably rearwardly) from the drinking surface and drinking aperture. The recyclable plastic film 110 of the disposable coffee cup lid film system 100 is temporarily adhered to the lid 10 via an adhesive such as glue or glue-type material. The recyclable plastic film 110 may be temporarily adhered to the lid 10 via an adhesive material (food-safe, and weakly adhering), non-adhesive (food-safe) or heating. Other materials or processes may be used to achieve the desired result. A non-adhesive is a material or process that connects the film to the lid without using an adhesive.

The recyclable plastic film 110 effectively prevents human touch to the lid 10 during handling, and as such the recyclable plastic film 110 is an isolator. As designed, the recyclable plastic film 110 effectively prevents germ-transfer, allergen-transfer, bacteria-transfer, and virus-transfer to the lid 10 during handling. In some embodiments, the plastic film is made of a food-grade material. One useful film is HC 8962 manufactured by Belmark, Inc.

Some specifications include: Background: CLEAR0.75 MR Clear Gloss BOPP Overlaminate Ink2.0 Mil Clear BOPP Removable Adhesive 1.2 Mil PET Liner

TABLE
Typical Values

| Property | Test Method | Units | Value |
|---|---|---|---|
| Total Thickness | ASTM D6988 | mils | 5.05 |
| Total Basis Weight | TM-20.020 | lbs/3,000 sq. | 83.59 |
| | | ft. ream | |
| Liner Basis Weight | TM-20.020 | lbs/3,000 sq. | 25.81 |
| | | ft. ream | |
| Minimum Application Temp. | Recommended | Degrees F. | 50 |
| Service Temperature Range | Recommended | Degrees F. | −20 to 130 |

The recyclable plastic film 110 may comprise functional indicia (not shown) such as logos or the like. The beverage container 20, as referred to here, may comprise a coffee cup or a non-coffee cup, wherein the beverage container 20 is suitable for removably containing hot and cold beverages.

According to one embodiment, the disposable coffee cup lid film system 100 may be arranged as a kit. In particular, the disposable coffee cup lid film system 100 may further include a set of instructions. The instructions may detail functional relationships in relation to the structure of the disposable coffee cup lid film system 100 such that the disposable coffee cup lid film system 100 can be used, maintained, or the like, in a preferred manner.

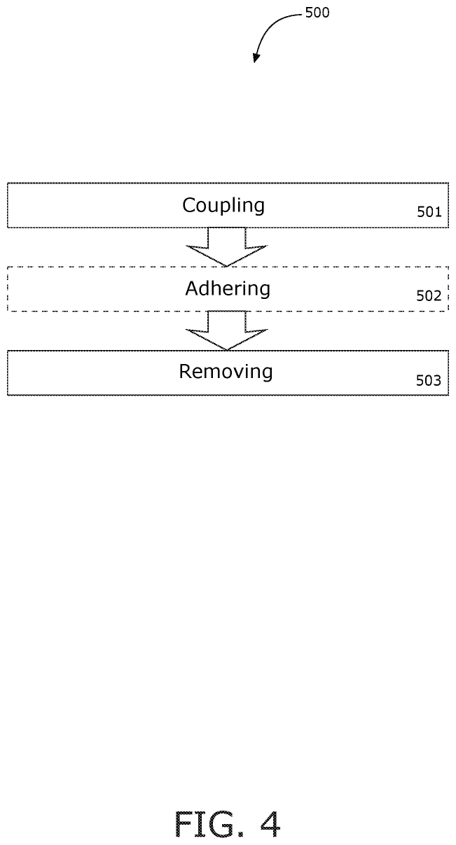

FIG. 4 is a flow diagram illustrating a method of use 500 for the disposable coffee cup lid film system 100, according to an embodiment of the present disclosure. In particular, the method of use 500 may include one or more components or features of the disposable coffee cup lid film system 100, as described above. As illustrated, the method of use 500 may include the steps of step one 501, coupling a recyclable plastic film to a lid, for maintaining the cleanliness of the lid of a beverage container before drinking; step two 502, optionally adhering the recyclable plastic film to the lid during or after manufacture of the lid; and step three 503, removing the recyclable plastic film from the lid just before drinking from the beverage container.

It should be noted that step 502 is an optional step and may not be implemented in all cases. Optional steps of the method of use 500 are illustrated using dotted lines in FIG. 5 to distinguish them from the other steps of the method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the disposable coffee cup lid film system, are taught herein.

The embodiments of the invention described herein are exemplary and numerous modifications, variations, and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A disposable beverage container lid film system comprising a recyclable plastic film removably coupled to a lid.

2. The system of claim 1, wherein the recyclable plastic film is transparent and comprises an engageable tab.

3. The system of claim 2, wherein the recyclable plastic film is temporarily adhered to the lid.

4. The system of claim 3, wherein an adhesive material temporarily adheres the lid to the recyclable plastic film.

5. The system of claim 4, wherein a non-adhesive material temporarily adheres the lid to the recyclable plastic film.

6. The system of claim 4, wherein the recyclable plastic film is temporarily adhered to the lid via heating.

7. The system of claim 4, wherein the recyclable plastic film is an isolator.

8. The system of claim 4, wherein the recyclable plastic film completely covers the lid blocking the lid from contacting the environment.

9. The system of claim 8, wherein the recyclable plastic film effectively prevents germ-transfer to the lid during handling.

10. The system of claim 8, wherein the recyclable plastic film effectively prevents allergen-transfer to the lid during handling.

11. The system of claim 8, wherein the recyclable plastic film effectively prevents bacteria-transfer to the lid during handling.

12. The system of claim 8, wherein the recyclable plastic film effectively prevents virus-transfer to the lid during handling.

13. The system of claim 8, wherein the recyclable plastic film comprises functional indicia.

14. The system of claim 1, wherein the beverage container is a cup.

15. The system of claim 1, wherein the beverage container is not a cup.

16. The system of claim 1, wherein the beverage container is suitable for containing hot and cold beverages.

17. A system comprising a recyclable plastic film removably coupled to a beverage container lid,
wherein the recyclable plastic film is transparent and comprises an engageable tab;
wherein an adhesive material temporarily adheres the lid to the recyclable plastic film;
wherein the recyclable plastic film completely covers the lid blocking the lid from contacting the environment;
wherein the recyclable plastic film is an isolator;
wherein the recyclable plastic film effectively prevents germ-transfer, allergen-transfer, bacteria-transfer, and virus-transfer to the lid during handling; and
wherein the recyclable plastic film comprises functional indicia.

18. The system of claim 17, further comprising set of instructions; and wherein the system is arranged as a kit.

19. A method of use for a cup lid film system, comprising the steps of:
coupling a recyclable plastic film to a lid, for maintaining cleanliness of the lid of a beverage container prior to drinking;
and
removing the recyclable plastic film from the lid prior to drinking from the beverage container.

20. The method of claim 19, further comprising the step of adhering the recyclable plastic film to the lid.
